(19) United States
(12) Patent Application Publication
(10) Pub. No.: US 2018/0221766 A1
(43) Pub. Date: Aug. 9, 2018

(54) CONTROL METHOD OF CONTROLLING GAME HANDLE SUPPORTING ANDROID GAME

(71) Applicant: SUZHOU SNAIL DIGITAL TECHNOLOGY CO., LTD., Suzhou (CN)

(72) Inventors: Junfeng ZHANG, Suzhou (CN); Lei DAI, Suzhou (CN)

(21) Appl. No.: 15/742,986

(22) PCT Filed: Jul. 6, 2016
(86) PCT No.: PCT/CN2016/088782

§ 371 Date: Jan. 9, 2018

(30) Foreign Application Priority Data
Jul. 10, 2015 (CN) 201510402119.6

(51) Int. Cl. A63F 13/40; A63F 13/23

(52) U.S. Cl. CPC A63F 13/40; A63F 2300/6045; A63F 13/23

(57) ABSTRACT

A control method, controlling a game handle supporting an android game, comprises the following steps: 1) receiving a button value of the game handle; 2) recording a present button coordinate and obtaining a button layout list of a present game interface; 3) moving, in order and according to an up, down, left, or right movement of the game handle, to an active button element configured on an interface, wherein a selected button pattern and a game button remain consistent; and 4) performing, using a handle confirmation button, a valid click. The control method of controlling the game handle supporting the android game enables consistency between a movement and operation of the interface button and those of the game button, allowing a user to visually perceive it as the game supports the game handle, thereby simplifying a user operation and enhancing user experience.

### FIELD OF THE DISCLOSURE

The present invention relates to a method for controlling a gamepad, in particular to a method for controlling a gamepad supporting Android games.

### BACKGROUND OF RELATED ART

In recent years, game consoles have become popular increasingly, and all of the major intelligent device manufacturers have strengthened efforts for development of devices based on Android system, such as intelligent TVs and game consoles, etc.

In the prior art, Android mobile games can realize click and sliding operations, etc., without any mouse or any other auxiliary device, owing to the support of a touch screen. Most large-screen games are directly ported from Android mobile terminals, and do not support a gamepad. TV consoles or large-screen display devices require the assistance of a mouse to realize interactive use since they are not equipped with a touch screen, causing severe inconvenience in game operations and experience to users who use a TV consoles or large-screen display device to play games.

### SUMMARY

To overcome the drawbacks in the prior art, the present invention provides a method for controlling a gamepad supporting Android games, which enables the user to execute game operations conveniently and improves user experience.

To attain the object described above, the method for controlling a gamepad supporting Android games provided in the present invention comprises the following steps:
1) receiving a button value from the gamepad;
2) recording present button coordinates, and obtaining a button layout list of a present game interface;
3) moving to an active button element configured on an interface orderly according to an up, down, left, right movement of the gamepad, and the style of a selected button is kept consistent with the style of a game button; and
4) performing a valid click, using a confirm button of the gamepad.

Furthermore, the step 2) further comprises the following steps: determining an unique element of the present interface by configuring a tool configuration, and saving button elements and position information on the present interface into a configuration file, loading a corresponding configuration according to the game, and finding out a corresponding interface according to the configuration, obtaining corresponding interface button layout elements from the interface configuration.

Furthermore, the step 4) further comprises the following step: clicking a selected area by the button when a user uses the gamepad to click the confirm button.

The method for controlling a gamepad supporting Android game provided in the present invention mainly attains the following technical effect: the movement and operation of the buttons of the interface are consistent with those of the game buttons, allowing the user to visually perceive it as the game supporting the gamepad, and thereby the method simplifies user operations and improves user experience.

Other features and advantages of the present invention will be described in the following text and become obvious partly from the description, or will be understood through implementation of the present invention.

### BRIEF DESCRIPTION OF THE DRAWINGS

The accompanying drawings are provided to help further understanding of the present invention, and constitute a part of the description. These drawings are used in conjunction with the embodiments to interpret the present invention, but do not constitute any limitation to the present invention. In the figures:

FIG. 1 is a flow diagram of the method for controlling a gamepad supporting Android game according to the present invention.

### DETAILED DESCRIPTION

Hereunder some preferred embodiments of the present invention will be described, with reference to the accompanying drawings. It should be appreciated that the embodiments described here are only provided to describe and interpret the present invention, but do not constitute any limitation to the present invention.

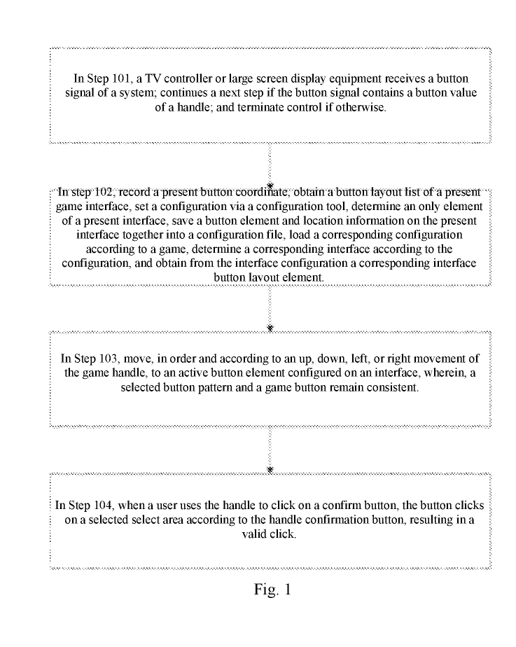

FIG. 1 is a flow diagram of the method for controlling a gamepad supporting Android games according to the present invention. Hereunder the method for controlling a gamepad supporting Android games of the present invention will be further detailed with reference to FIG. 1.

First, in step 101, a TV console or large-screen display device receives a button signal from a system; the next step will be executed if it is found that the button signal contains a button value of the gamepad; otherwise the control is terminated.

In step 102, the present button coordinates are recorded, and a button layout list of a present game interface is obtained; unique element of the present interface are determined by configuring a tool configuration, and button elements and position information of the present interface are saved into a configuration file, a corresponding configuration is loaded according to the game, and a corresponding interface is found according to the configuration, corresponding interface button layout elements are obtained from the interface configuration.

In step 103, movement is executed to an active button element configured on the interface orderly according to an up, down, left, right movement of the gamepad, and the style of a selected button is kept consistent with the style of a game button.

In step 104, a selected area is clicked by the button when a user uses the gamepad to click a confirm button, and thereby a valid click is accomplished.

With the method for controlling a gamepad supporting Android game of the present invention, the movement and operation of the buttons of the interface are consistent with those of the game buttons, allowing the user to visually perceive it as the game supporting the gamepad; in the gaming process with a large-screen console or any other Android console, the movement of a mouse is controlled with the gamepad, and the position of the mouse is determined by means of movement in user-defined squares, the change of the position is controlled by means of up, down, left, right movement of the gamepad, a mouse click operation is simulated with the confirm button on the gamepad, and the click is executed at the position of the corresponding square. Thus, the user can operate conveniently, and the user experience is improved.

Those skilled in the art should appreciate: the embodiments described above are only some preferred embodiments of the present invention, and should not be deemed as constituting any limitation to the present invention. Though the present invention is described and illustrated in detail with reference to the embodiments, the present invention is not limited to these embodiments. Those skilled in the art can easily make modifications to the technical scheme described above in the embodiments or make equivalent replacement of some technical features. Any modification, equivalent replacement, or refinement to the embodiments without departing from the spirit and the principle of the present invention shall be deemed as falling into the scope of protection of the present invention.

We claim:

1. A method for controlling a gamepad supporting Android games, comprising the following steps:
1) receiving a button value from the gamepad;
2) recording present button coordinates, and obtaining a button layout list of a present game interface;
3) moving to an active button element configured on an interface orderly according to an up, down, left, right movement of the gamepad, and the style of a selected button is kept consistent with the style of a game button; and
4) performing a valid click, using a confirm button of the gamepad.

2. The method for controlling a gamepad supporting Android games according to claim 1, wherein, the step 2) further comprises the following steps: determining an unique element of the present interface by configuring a tool configuration, and saving button elements and position information on the present interface into a configuration file, loading a corresponding configuration according to the game, and finding out a corresponding interface according to the configuration, obtaining corresponding interface button layout elements from the interface configuration.

3. The method for controlling a gamepad supporting Android games according to claim 1, wherein, the step 4) further comprises the following step: clicking a selected area by the button when a user uses the gamepad to click the confirm button.
